(19) United States
(12) Patent Application Publication
(10) Pub. No.: US 2012/0156591 A1
(43) Pub. Date: Jun. 21, 2012

(54) METHOD OF FABRICATION OF FUEL CELL

(76) Inventor: Sukyal Cha, Fremont, CA (US)

(21) Appl. No.: 13/332,105

(22) Filed: Dec. 20, 2011

Related U.S. Application Data
(60) Provisional application No. 61/424,917, filed on Dec. 20, 2010.

(51) Int. Cl. H01M 8/00

(52) U.S. Cl. 429/535

(57) ABSTRACT

A method of fabrication of a fuel cell includes depositing an anode catalyst on a first carbon support by a metal organic vapor deposition, depositing a cathode catalyst on a second carbon support by a metal organic vapor deposition method, fabricating an anode including the anode catalyst, fabricating the cathode including the cathode catalyst, and providing the anode and the cathode on opposite sides of a membrane of the fuel cell. Another method includes providing first carbon support on anode side of membrane and providing second carbon support on a cathode side of the membrane. The method further includes depositing an anode catalyst on the first carbon support by a metal organic vapor deposition and depositing a cathode catalyst on the second carbon support by a metal organic vapor deposition and providing gas diffusion layer on each of the anode side and the cathode side of the membrane.

### CROSS-REFERENCE TO RELATED APPLICATIONS

This application claims the benefit of U.S. Provisional Application No. 61/424,917, filed Dec. 20, 2010.

### FIELD OF INVENTION

The embodiments herein relate to fuel cells, and more particularly to a method of fabrication of fuel cells.

### BACKGROUND OF INVENTION

Electrochemical fuel cells convert fuel and oxidant to electricity and reaction product. A fuel cell, like an ordinary battery, provides direct current electricity from two electrochemical reactions which occur at electrodes to which reactants are fed. A fuel cell stack typically includes a series of individual fuel cells. Each cell includes a pair of anode and cathode. A voltage across each cell is determined by the type of electrochemical reaction occurring in the cell. For example, for a typical direct methanol fuel cell (DMFC), the voltage can vary from 0 V to 0.9 V, depending on a current being generated. The current being generated in the cell depends on the operating condition and design of the cell, such as electro-catalyst composition or distribution and active surface area of a membrane electrode assembly (MEA), characteristics of a gas diffusion layer (GDL), flow field design of an anode and cathode, bi-polar plates, cell temperature, reactant concentration, reactant flow and pressure distribution, reaction by-product removal, and so forth. The reaction area of a cell, number of cells in series, and the type of electrochemical reaction in the fuel cell stack determine a current and hence a power supplied by the fuel cell stack.

In a typical DMFC cell, a negative electrode is maintained by supplying a fuel such as a liquid methanolic solution. A concentration of the methanolic solution is in the range of 0.5 M to 5 M. Further, a positive electrode in the DMFC cell is maintained by supplying oxygen or air. When providing a current, methanol is electrochemically oxidized at an anode electro-catalyst to produce electrons, which travel through an external circuit to a cathode electro-catalyst where the electrons are consumed together with oxygen in a reduction reaction.

An ionic conducting membrane, which is typically formed of a perfluorosulfonic acid (PFSA)-based material such as Nafion®, is sandwiched and hot-pressed with two electrodes, which are catalyzed with platinum-ruthenium alloy (PtRu/C) and platinum (Pt/C) catalysts for anode and cathode, respectively.

Further, the electrodes for anode and cathode are typically fabricated by coating catalyst inks which consists of catalysts, ionic conduction material dispersion such as Nafion ionomer solution, solvents, and deionized water, on GDLs. GDLs are used to establish electronic contact and aid mass transport. The GDLs allow access to methanolic solution and remove carbon dioxide (CO₂) gas formed at the anode side. At the cathode side, the GDLs allow access to air and remove water.

Hydrophobic polymers such as Polytetrafluoroethylene (PTFE) are typically used to facilitate removal of CO₂ and liquid water at the anode and cathode catalyst layers, respectively. Conventional methods of applying PTFE in the catalyst layer include making Teflonized catalyst powder with PTFE dispersion. However, mixing PTFE dispersion with catalyst reduces catalyst electrochemical surface area and electronic conductivity due to coverage of the catalyst surface with PTFE. This conventional catalyst ink preparation method is a wet process, which also introduces ionic contamination issues. Furthermore, a wet process generates wastes and requires specialized processing to reclaim the precious metal content. Therefore, a conventional wet process results in reduced performance and higher cost of MEA fabrication.

Therefore, there is a need for a method of fabrication of fuel cell which at least increases a catalyst electrochemical surface area and addresses ionic contamination issues among other advantages.

### SUMMARY

Accordingly, an embodiment of the invention provides a method of fabrication of a fuel cell. The method includes depositing an anode catalyst on a first carbon support by a metal organic vapor deposition, depositing a cathode catalyst on a second carbon support by a metal organic vapor deposition method, fabricating an anode including the anode catalyst, fabricating the cathode including the cathode catalyst, and providing the anode and the cathode on opposite sides of a membrane of the fuel cell.

Further, another embodiment of the invention provides a method of fabrication of a fuel cell. The method includes providing a first carbon support on an anode side of a membrane and providing a second carbon support on a cathode side, opposite to the anode side, of the membrane. The method further includes depositing an anode catalyst on the first carbon support by a metal organic vapor deposition and depositing a cathode catalyst on the second carbon support by a metal organic vapor deposition and providing gas diffusion layer on each of the anode side and the cathode side of the membrane.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 is a flow chart illustrating a method of fabrication of fuel cell according to an embodiment as disclosed herein;

FIG. 1A depicts a fuel cell fabricated according to the embodiments as disclosed in FIG. 1;

FIG. 1B depicts a Gas Diffusion Layer (GDL) along with catalyst layer of anode of the fuel cell as disclosed in FIG. 1A;

FIG. 1C depicts a Gas Diffusion Layer (GDL) along with catalyst layer of cathode of the fuel cell as disclosed in FIG. 1A;

FIG. 2 is a flow chart illustrating a method of fabrication of fuel cell according to another embodiment as disclosed herein;

FIG. 2A depicts a fuel cell fabricated according to the embodiments as disclosed in FIG. 2;

FIG. 2B depicts a catalyst coated membrane of the fuel cell as disclosed in FIG. 2A.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

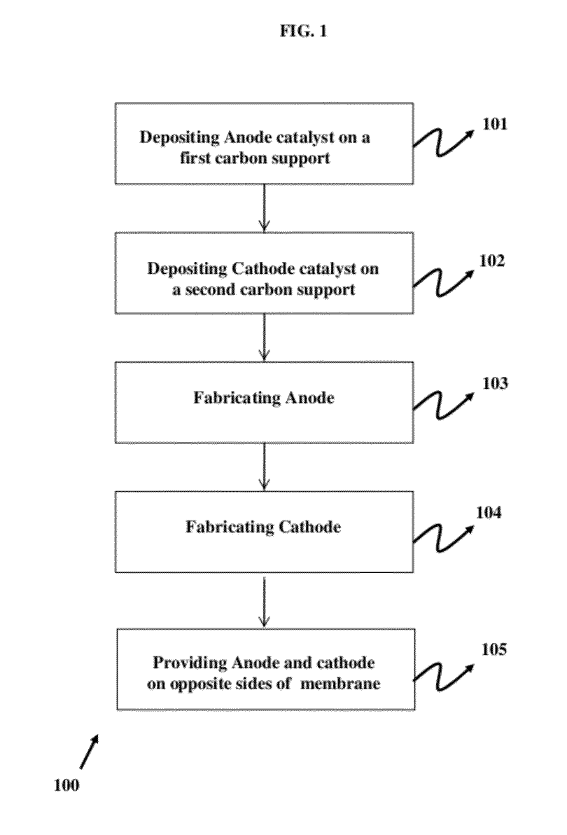

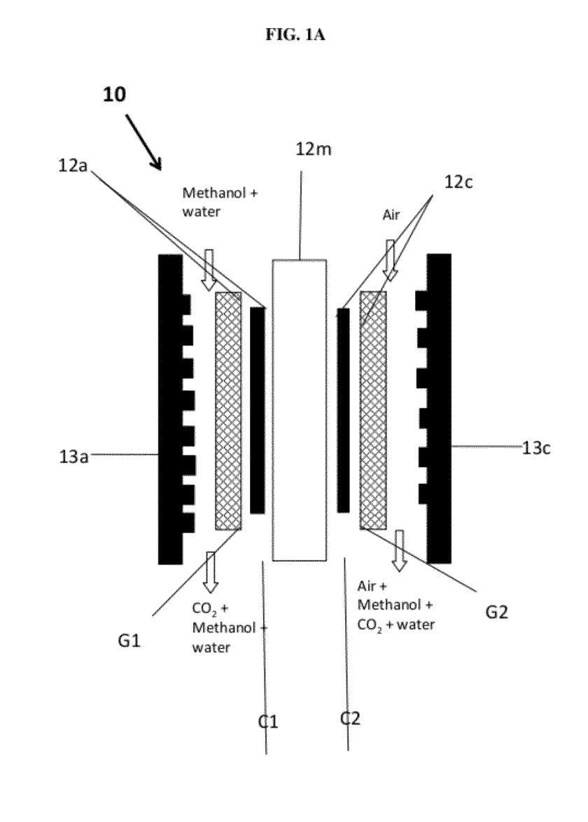

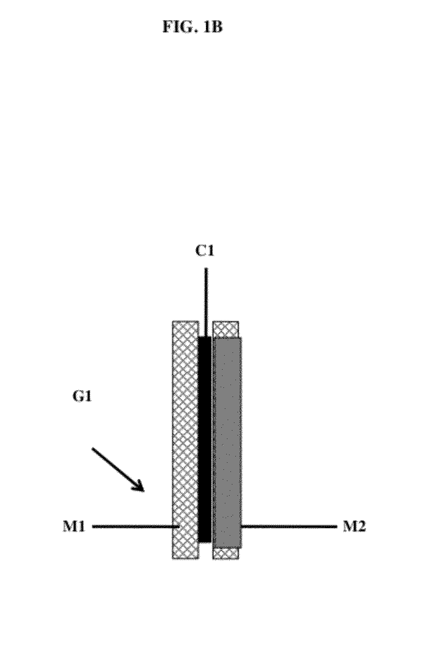

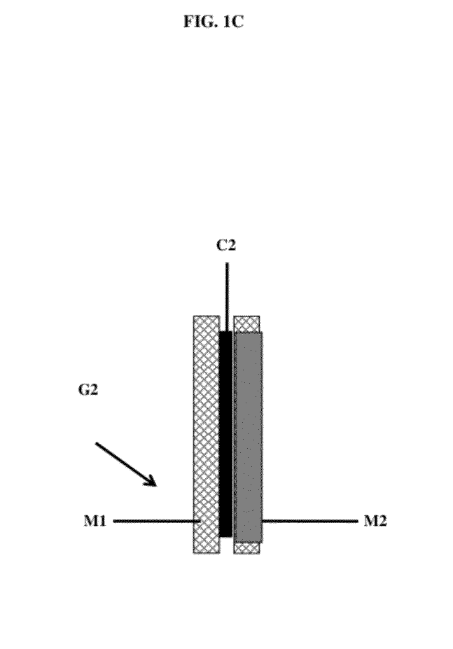

Now, the embodiments as disclosed in FIGS. 1-1C are explained herein below. It should be noted that for the purpose of better understanding, the structure of the fuel cell has been explained first followed by the method of fabrication. FIG. 1A depicts a fuel cell 10 having a negative electrode 12a (anode), a positive electrode 12c (cathode), a membrane 12m, an anode flow field plate 13a and a cathode flow field plate 13c. For the purpose of description, the fuel cell 10 is considered as a direct methanol fuel cell (DMFC). The anode 12a includes a gas diffusion layer G1 and a catalyst layer C1. Further, the cathode 12c includes a gas diffusion layer G2 and a catalyst layer C2. The anode 12a is maintained by supplying a fuel such as a liquid methanolic solution (e.g., having a concentration in the range of 0.5 M to 5 M) and the cathode 12c is maintained by supplying oxygen or air. When providing a current, methanol is electrochemically oxidized at an anode electro-catalyst to produce electrons. The electrons travel through an external circuit (not shown) to a cathode electro-catalyst where the electrons are consumed together with oxygen in a reduction reaction. A circuit is maintained within the direct methanol fuel cell 10 (DMFC) by the conduction of protons in the membrane 12m.

Further, as shown in FIGS. 1B-1C, each of the gas diffusion layers G1 and G2 of the anode 12a and cathode 12c, respectively, includes a micro porous layer M1 and a macro porous layer M2. The catalyst layer C1 of the anode 12a is provided between the micro porous layer M1 and the macro porous layer M2 of the gas diffusion layer G1. The catalyst layer C1 includes a first carbon support S1 (not shown) and the catalyst layer C2 includes a second carbon support S2 (not shown).

Now, with reference to FIG. 1, the method 100 of fabrication of fuel cell 10 according to an embodiment of the instant invention includes depositing anode catalyst on the first carbon support S1 (step 101), depositing cathode catalyst on the second carbon support S2 (step 102), fabricating the anode 12a (step 103), fabricating the cathode 12c (step 104) and providing the anode 12a and cathode 12c on opposite sides of the membrane 12m (step 105).

Depositing anode catalyst (step 101) includes identifying catalyst for anode and depositing the catalyst by metal-organic vapor deposition (MOCVD) on the first carbon support S1. Various metal-organic precursors of platinum (Pt) and ruthenium (Ru) which can be easily decomposed and deposited at 120˜400 degree Celsius and 1,000˜90,000 Pa are selected. The vacuum pressure is selected such that the pressure can affect sublimation temperature or boiling temperature of metal organic precursor. The metal precursors for the anode catalyst are metal (Pt, Pd, Ni, Au, Ag, Cu, Ir, Rh, Co, Os, Ru, Fe, Re, Tc, Mn, W, Mo, Cr) acetyleacetonate (2,4-pentanedionate) and carbonyl. In one embodiment, the anode catalyst is Platinum (II) 2,4-pentanedionate, Ruthenium (III) 2,4-pentanedionate, Palladium (II) 2,4-pentanedionate. The anode catalyst is then deposited on the first carbon support S1.

Further, depositing cathode catalyst (step 102) includes identifying catalyst for cathode and depositing the catalyst by metal-organic vapor deposition (MOCVD) on the second carbon support S2. In one embodiment, the cathode catalyst is Platinum (II) 2,4-pentanedionate which is mixed with carbon, which has 100˜10000 m2/g surface area, and only platinum (Pt) is deposited on carbon after MOCVD. Water can be introduced in order to accelerate decomposition time of precursor keeping 0.05˜0.5 PH₂O (partial pressure) and nitrogen environment. Thereafter, the temperature of vacuum chamber is increased to 120˜400 degree Celsius. In one embodiment, the temperature of vacuum chamber is kept in the range of 150˜250 degree Celsius for platinum Pt (II) 2,4-pentanedionate for more than 10 min. Finally, platinum (Pt) is deposited on the second carbon support S2.

Fabricating anode (103) is explained herein below. The deposition of anode catalyst on the first carbon support S1 forms the catalyst layer C1. The catalyst layer C1 thus formed is provided between the macro porous layer M1 and the micro porous layer M2 of the gas diffusion layer G1 of the anode 12a. In an embodiment, the catalyst layer C1 is hot bonded at least to the layer M2 or decal transferred thereto. Further, in an embodiment, the micro porous layer M1 of the gas diffusion layer G1 is thinner than 200 microns.

In an embodiment, the first carbon support S1 is a poly tetra fluoro ethylene (PTFE) film coated with a mixture of carbon and Nafion ionomer solution.

Further, fabricating cathode (step 104) is explained herein below. The deposition of cathode catalyst on the second carbon support S2 forms the catalyst layer C2. The catalyst layer C2 thus formed is provided between the macro porous layer M1 and the micro porous layer M2 of the gas diffusion layer G2 of the cathode 12c. In an embodiment, the micro porous layer M1 of the gas diffusion layer G2 is thinner than 200 micron.

Further, the micro porous layer M1 provided near the catalyst layer C2 is hydrophobic thereby facilitating easy removal of liquid water from the catalyst layer C2. In an embodiment, the micro porous layer M1 is used as the second carbon support S2. In an embodiment, hydrophobic micro porous layer M1 is coated on blank substrate such as stainless steel 316 film using the mixture of PTFE dispersion and carbon by rod coating or knife coating. Thereafter, residual solvents are vaporized or decomposed. The micro porous layer M1 becomes the final substrate for platinum Pt deposition via Pt(II) 2,4-pentanedionate MOCVD. Platinum, Pt(II) 2,4-pentanedionate can be directly coated by various coating methods such as rod coating and knife coating via dry coating or Pt(II) 2,4-pentanedionate solution with acetone solvent. After platinum Pt deposition on the micro porous layer M1, Nafion ionomer solution is applied onto Pt-coated micro porous layer M1 and is hot-pressed with macro porous layer M2. In this application, Pt is not deposited on the PTFE surface of micro porous layer M1, which means there is no reduction or waste of Pt surface by the MOCVD.

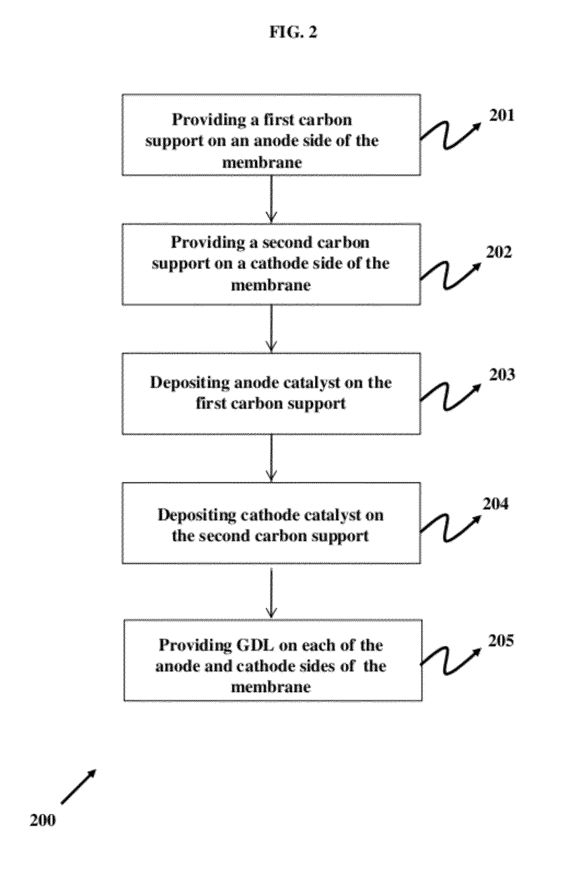

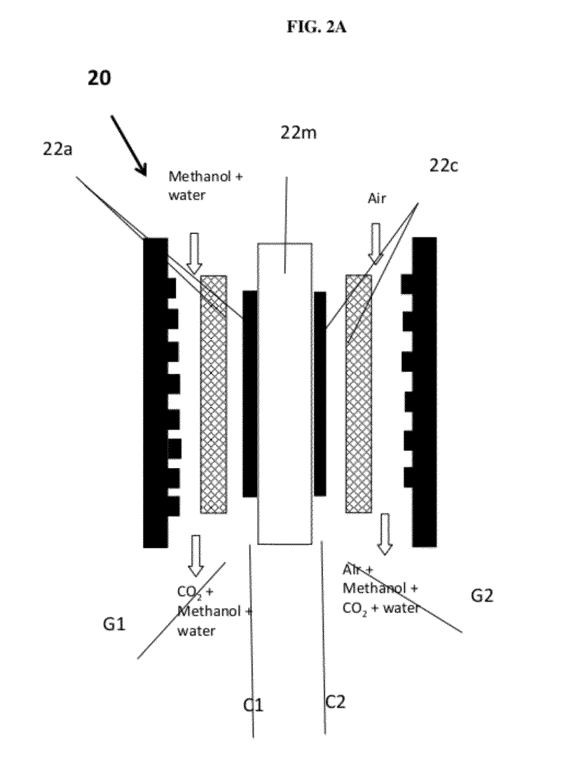

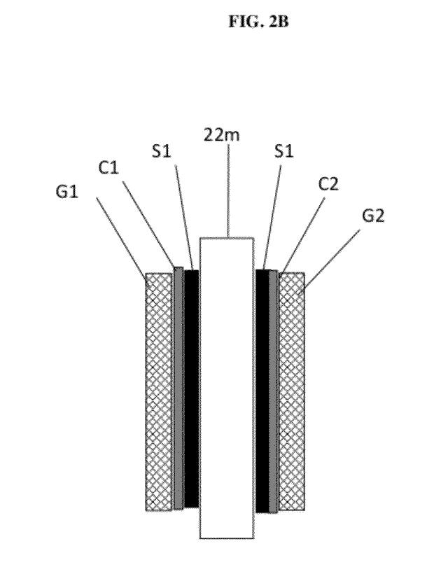

Now, the embodiments as disclosed in FIGS. 2-2B are explained herein below. It should be noted that for the purpose of better understanding, the structure of the fuel cell has been explained first followed by the method of fabrication. FIG. 2A depicts a fuel cell 20 having a negative electrode 22a (anode), a positive electrode 22c (cathode), a membrane 22m, an anode flow field plate 23a and a cathode flow field plate 23c. For the purpose of description, the fuel cell 20 is considered as a direct methanol fuel cell (DMFC). The anode 22a includes a gas diffusion layer G1 and a catalyst layer C1. Further, the cathode 22c includes a gas diffusion layer G2 and a catalyst layer C2. The anode 22a is maintained by supplying a fuel such as a liquid methanolic solution (e.g., having a concentration in the range of 0.5 M to 5 M) and the cathode 22c is maintained by supplying oxygen or air. When providing a current, methanol is electrochemically oxidized at an anode electro-catalyst to produce electrons. The electrons travel through an external circuit (not shown) to a cathode electro-catalyst where the electrons are consumed together with oxygen in a reduction reaction. A circuit is maintained within the direct methanol fuel cell 20 (DMFC) by the conduction of protons in the membrane 22m.

Further, as shown in FIG. 2B, each of the gas diffusion layers G1 and G2 of the anode 22a and cathode 22c, respectively, includes a micro porous layer M1 and a macro porous layer M2. The catalyst layer C1 of the anode 22a is provided on a first side of the membrane 22m. The catalyst layer C2 of the cathode 22c is provided one a second side opposite to the first side of the membrane 22m. The catalyst layer C1 includes a first carbon support S1 and the catalyst layer C2 includes a second carbon support S2.

Now, with reference to FIG. 2, the method 200 of fabrication of fuel cell 20 according to an embodiment of the instant invention includes providing a first carbon support on an anode side of the membrane 22m (step 201), providing a second carbon support on a cathode side of the membrane 22m (step 202), depositing anode catalyst on the first carbon support S1 (step 203), depositing cathode catalyst on the second carbon support S2 (step 204) and providing gas diffusion layers G1 and G2 on each of the anode and cathode sides of the membrane 22m (step 205).

The depositing of anode catalyst on the first carbon support S1 (step 203) and the depositing of cathode catalyst on the second carbon support S2 (step 204) is done via MOCVD. Further, in an embodiment, each of the first and second carbon support S1 and S2 includes a mixture of carbon and Nafion ionomer solution coated on the first and second side of the membrane 22m to form a catalyst coated membrane. The deposition of anode and cathode catalyst (steps 203 and 204) are done sequentially. While depositing the anode catalyst (step 203), the second side (cathode side) of the membrane 22m is sealed with PTFE mask and while depositing the cathode catalyst (step 204), the first side (anode side) of the membrane 22m is sealed with PTFE mask. In an embodiment, the cathode catalyst is platinum Pt(II) 2,4-pentanedionate and the anode catalyst is Platinum ruthenium Pt/Ru alloy. Thereafter, the gas diffusion layers G1 and G2 are provided on the first and second side of the membrane 22m.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method of fabrication of a fuel cell, said method comprising:
depositing an anode catalyst on a first carbon support by a metal organic vapor deposition;
depositing a cathode catalyst on a second carbon support by a metal organic vapor deposition method;
fabricating an anode including said anode catalyst;
fabricating a cathode including said cathode catalyst; and
providing said anode and said cathode on opposite sides of a membrane of the fuel cell.

2. The method as claimed in claim 1, wherein said anode catalyst includes metal organic precursors of platinum and ruthenium.

3. The method as claimed in claim 2, wherein said metal precursors include Pt, Pd, Ni, Au, Ag, Cu, Ir, Rh, Co, Os, Ru, Fe, Re, Tc, W, Mo, Cr acetyleacetonate, 2,4-pentanedionate and carbonyl.

4. The method as claimed in claim 1, wherein said anode catalyst is platinum (II) 2,4-pentanedionate, Ruthenium (III) 2,4-pentanedionate, palladium (II) 2,4-pentanedionate.

5. The method as claimed in claim 1, wherein said cathode catalyst is platinum (II) 2,4-pentanedionate.

6. The method as claimed in claim 5, wherein said platinum (II) 2,4-pentanedionate is mixed with carbon having a surface area of about 100-10000 m2/g.

7. The method as claimed in claim 6, wherein depositing the cathode catalyst comprises:
introducing water to accelerate decomposition time of platinum (II) 2,4-pentanedionate;
providing a partial pressure of 0.05-0.5 PH2O in a nitrogen environment; and
increasing a temperature of a vacuum chamber to 120 to 400 degree Celsius.

8. The method as claimed in claim 1, wherein fabricating said anode includes providing said anode catalyst between a micro porous layer and a macro porous layer of a gas diffusion layer.

9. The method as claimed in claim 8, wherein said anode catalyst is hot bonded to said micro porous layer.

10. The method as claimed in claim 8, wherein said anode catalyst layer is decal transferred to said micro porous layer.

11. The method as claimed in claim 8, wherein a thickness of said micro porous layer is less than 200 mm.

12. The method as claim in claim 1, wherein fabricating said cathode includes providing said cathode catalyst between a micro porous layer and a macro porous layer of a gas diffusion layer.

13. The method as claimed in claim 12, wherein said micro porous layer is hydrophobic.

14. A method of fabrication of a fuel cell, said method comprising:
providing a first carbon support on an anode side of a membrane;
providing a second carbon support on a cathode side, opposite to said anode side, of said membrane;
depositing an anode catalyst on said first carbon support by a metal organic vapor deposition;
depositing a cathode catalyst on said second carbon support by a metal organic vapor deposition; and
providing gas diffusion layer on each of said anode side and said cathode side of the membrane.

15. The method as claimed in claim 14, wherein each of said first and second carbon supports include a mixture of carbon and Nafion ionomer solution.

16. The method as claimed in claim 14, wherein depositing said anode catalyst and depositing said cathode catalyst is done sequentially.

17. The method as claimed in claim 16, wherein
when depositing said anode catalyst said cathode side of the membrane is sealed with a polytetrafluoroethelyne (PTFE) mask; and
when depositing said cathode catalyst said anode side of the membrane is sealed with a polytetrafluoroethelyne (PTFE) mask.
